(19) United States
(12) Patent Application Publication
(10) Pub. No.: US 2002/0087349 A1
(43) Pub. Date: Jul. 4, 2002

(54) System and method for increasing perceived value of property to tenants

(76) Inventor: Ah Long Wong, Singapore (SG)

Correspondence Address: SQUIRE, SANDERS & DEMPSEY L.L.P, 600 HANSEN WAY, PALO ALTO, CA, 94304-1043, US

(21) Appl. No.: 10/010,139

(22) Filed: Dec. 5, 2001

Related U.S. Application Data
(60) Provisional application No. 60/258,752, filed on Dec. 29, 2000.

(51) Int. Cl. G06F 17/60

(52) U.S. Cl. 705/1

(57) ABSTRACT

A method and system for increasing perceived value of a property to tenants. The method and system comprises providing space in a property to tenants; gathering business information about tenants in the property; negotiating with vendors for tenants' needs using tenants' aggregated purchasing power; and introducing tenants to each other based on the gathered business information so that tenants may consummate business relationships.

### PRIORITY REFERENCE TO PRIOR APPLICATIONS

This application claims benefit of and incorporates by reference patent application Ser. No. 60/258,752, entitled “FACILITY SERVICE PROVIDER (FSP),” filed on Dec. 29, 2000, by inventor Ah Long Wong.

### TECHNICAL FIELD

This invention relates to facility service providers, and more particularly, but not exclusively, provides a system and method for increasing a perceived value of a real estate property relative to other properties.

### BACKGROUND

Conventional commercial and/or industrial property owners lease space to tenants, such as stores, restaurants, technology companies, etc. in exchange for monetary payment. In locations of scarce property available for lease, solely having commercial and/or industrial property to offer potential tenants is a recipe for success. However, when ample supplies of commercial and/or industrial property are available, property owners must do more to differentiate their properties from other properties in order to attract potential tenants and possibly even charge higher lease rates.

Accordingly, a new system and method for increasing the value of real estate to tenants is needed.

### SUMMARY

The present invention provides a system for increasing value of a real estate property relative to other properties. The system comprises a facility service provider and commercial property for leasing to tenants. The facility service provider (FSP) leases property to tenants in exchange for money and/or equity in tenants. In addition, the FSP gathers information about tenants, their services and their needs; enters into non-exclusive business relationships relating to the property with third party vendors, thereby forcing them to compete for tenant business; negotiates with these third party vendors based on aggregation of tenants' purchasing power, thereby leading to lower costs for tenants purchasing services or products from the vendors; introduces tenants to each other to encourage networking and to establish business relationships among tenants; and searches for best breed of innovative products and services to anticipate future needs of tenants.

The commercial property is wired for broadband access and include a variety of different methods for leasing to a plurality of tenants, including space for offices, restaurants, shops, etc. The FSP also runs a start-up incubator and virtual offices in the property.

The system further includes a community web portal, with intranet capabilities, to enable tenants to shop, sell, acquire goods and services, book restaurant and/or travel reservations, etc. In addition, the system includes a common telecommunication connection and an Internet Call Center (as further described below). The common telecommunication connection enables tenants to call each other at no charge, thereby encouraging networking among tenants.

The system also includes an InfoCam system (as further described below) for relaying real-time information to tenants and visitors to the property. The system also includes a club house with exercise facilities, a car park, security services and other features.

The present invention further provides a method for increasing value of a real estate property relative to other properties. The method comprises: leasing space to tenants, such as stores, offices, restaurants, etc., in exchange for monetary payments and/or equity in the tenants; gathering information about the tenants, including their services and their needs; entering into non-exclusive business relationships with third party vendors for tenants' needs, thereby forcing the vendors to compete for tenants' business; negotiating with third party vendors for products and/or services based on aggregation of tenants to leverage price reductions typically only obtainable by large corporations; introducing tenants to each other so as to encourage them to form business relationships advantageous to each other; and searching for best breed of innovative products and services to anticipate future needs of tenants.

The system and method advantageously increases potential and current tenants' perceived value of the property.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a FSP network system in accordance with an embodiment of the invention;

FIG. 2A is a diagram illustrating relationships among an FSP, tenants, and third party vendors;

FIG. 2B is a diagram illustrating relationships between an FSP and tenants;

FIG. 3 is a block diagram illustrating waves of an FSP;

FIG. 4 is a block diagram illustrating a community portal; and

FIG. 5 is a flowchart illustrating a method for increasing perceived value of a property.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

In real estate developments, location is becoming less important as compared to connectivity as a key factor of success. The Internet makes rapid communication within and external to companies extremely easy and rapid. Further, the Internet enables communication within a company to be shared easily, as compared to conventional systems in which communication is done in a hierarchical fashion. Communication of knowledge helps to create value through improved efficiency, flexibility, accountability, openness, empowerment and time to market.

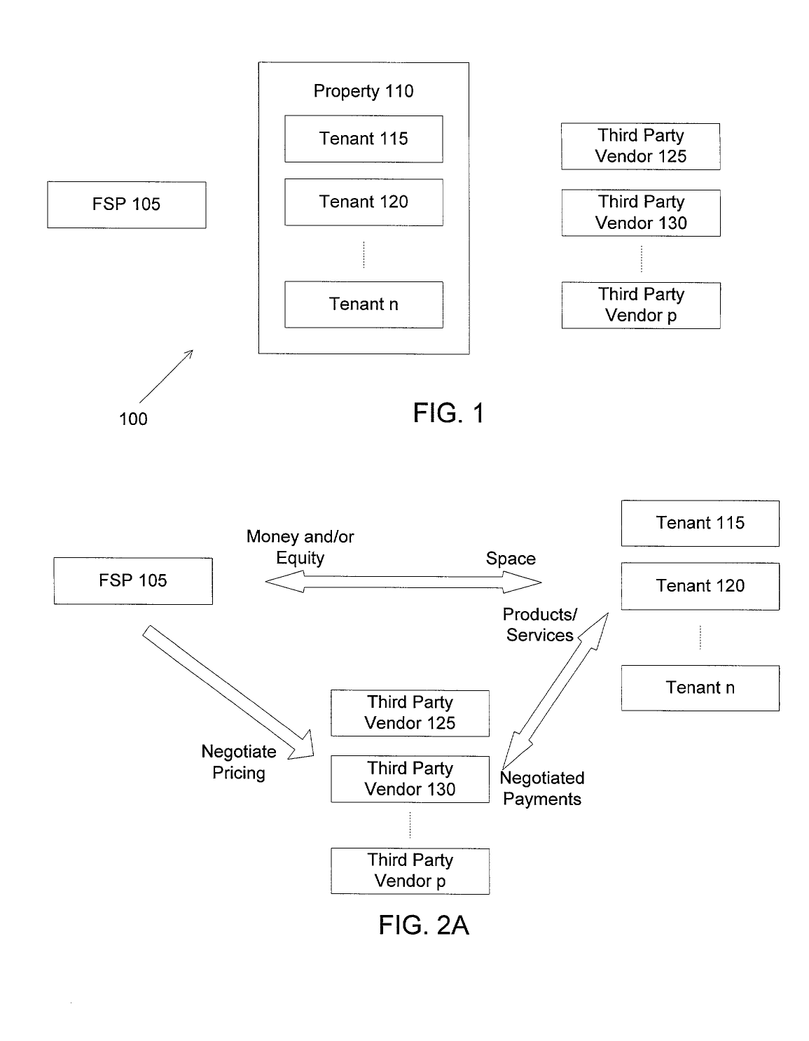

FIG. 1 is a block diagram illustrating a FSP network system 100, which includes a FSP 105, property 110, and a plurality of third party vendors 125, 130-p. Property 110 also includes a plurality of tenants 115, 120-n. FSP 105 operates property 110 including leasing space to tenants and building and managing network 100, as will be discussed further below. FSP 105 includes a corporate entity; a computerized realty system, with or without artificial intelligence, for assigning portions of property 110 to tenants and/or accepting payment for property 110 leases; an individual or individuals authorized to lease portions of property 110, etc. Property 110 can be a commercial and/or industrial property divided into spaces for lease to tenants. Tenants 115, 120-n may include stores, corporations, law firms, restaurants, etc. that occupy space in property 110.

According to Metcalfe's Law relating to networks, such as network 100, the value in terms of usefulness or utility of a network is equal to the square of the number of users, e.g., tenants 115, 120-n. Metcalfe's law therefore indicates that it is beneficial to be part of a growing network. Accordingly, the more tenants that join the network by leasing space from FSP 105 in property 110, the more the value of the network increases. Further, the value of the network can be increased by the variety of tenants, e.g., not all tenants are in identical fields and therefore competitors.

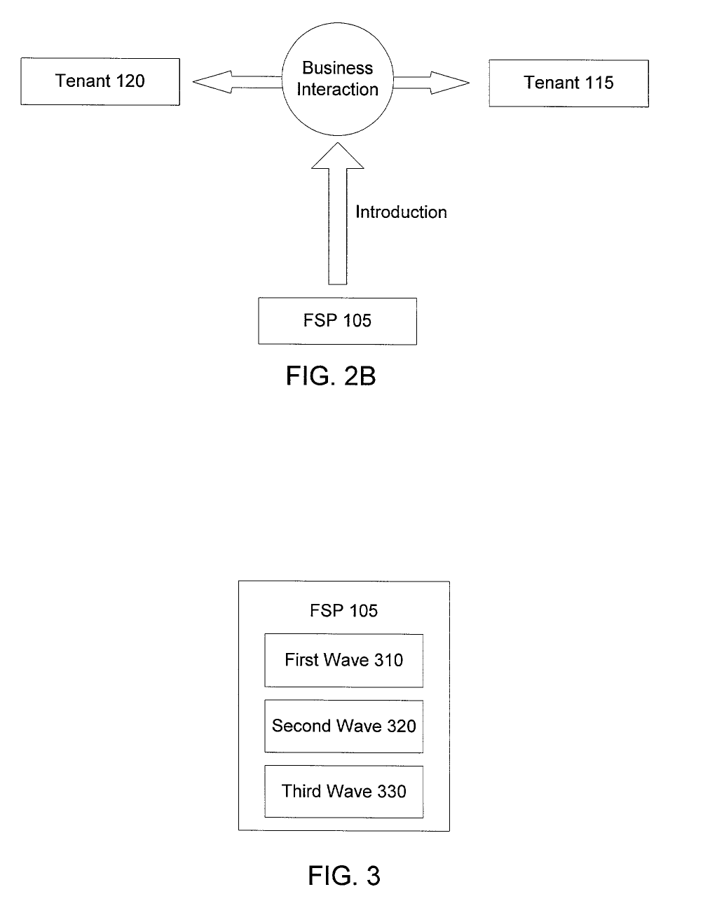

FIG. 2A is a diagram illustrating relationships among FSP 105, tenants 115, 120-n, and third party vendors 125, 130-p. In one type of relationship, FSP 105 leases space in building 110 to tenants 115, 120-n in exchange for money. Tenants 115, 120-n pays FSP 105 for space on a monthly or yearly basis, on other basis. In an alternative embodiment, tenants 115, 120-n provide equity (e.g., stock, convertible bonds, etc.) in place of or in addition to money in exchange for space. By enabling tenants to lease space for equity, tenants can gain access to network 100 even though they otherwise would not be able to afford access.

In addition, FSP 105 can aggregate demand for products and/or services from tenants 115, 120-n in order to negotiate lower prices from third party providers 125, 130-p, thereby adding value to joining network 100. For example, tenants 115, 120-n may all have a need for computers. Conventionally, tenants 115, 120-n can each individually purchase computers, possibly paying list prices. Alternatively, in an embodiment of the invention, FSP 105 can aggregate demand from tenants 115, 120-n for computers and negotiate volume discounts with providers 125, 130-p, thereby adding value to network 100.

In another embodiment of the invention, FSP 105 can enter into non-exclusive business relationships with providers 125, 130-p to supply products and/or services to tenants 115, 120-n, thereby making providers 125, 130-p compete with each other for tenants' business. For example, FSP 105 can actively engage with a plurality of broadband service providers to lay infrastructure and compete for business among tenants 115, 120-n. Due to the competition among the broadband service providers, the price of Internet service is less than at comparable buildings.

FIG. 2B is a diagram illustrating relationships between FSP 105 and tenants 115, 120-n. FSP 105 can gather business information about tenants 115, 120-n, their services and their needs. Based on this information, FSP 105 can introduce tenants to each other so that the tenants can form relationships with each other based on their needs and services/products, thereby enhancing the value of network 100. For example, tenant 115 may include a network consulting division for setting up computer networks for corporations and tenant 120 may have a need for a computer network. FSP 105, based on gathered business information, can introduce tenant 115 to tenant 120 so that they may consummate a business relationship, thereby increasing sales for tenant 115 and fulfilling the need of tenant 120 for an installed network.

Alternatively, tenants may have competitive relationships instead of complementary relationships. For example, both tenant 115 and tenant 120 may produce similar products, thereby possibly placing them in competition with each other to sell products to the same customers. However, as tenants 115 and 120 are both part of network 100, FSP 105 can encourage a cooperative relationship between tenants 115 and 120 so that the tenants can take advantage of their complementary strengths, exchange market intelligence, coordinate essential supplies of their offerings, outsource one another's work, conduct joint research and development, joint product development, joint promotions and joint activities.

FIG. 3 is a block diagram illustrating waves of FSP 105. FSP 105 includes batches of services that are called “waves.” The waves enable FSP 105 to increase the perceived value of property 110 to tenants by increasing the connectivity (and therefore value) of network 100. In an embodiment of the invention, FSP 105 includes a first wave 310, second wave 320, and a third wave 330. First wave 310 includes, as discussed above, rent for equity, in which space from property 110 is leased to a tenant in exchange for equity. First wave 310 also includes instant networking, broadband access, an incubator, digital offices, community portal, common telecommunications connection, internet call center, InfoCam system (as explained below), club house, networking meetings, car park, and security services. FSP 105 provides instant networking to new tenants by having a pre-existing network, such as network 100. FSP 105 also provides broadband access, via fiber optic cable infrastructure, to tenants, thereby enabling Internet communication.

FSP 105 also provides an incubator for startup companies. The incubator provides: shared office space; 180-day business accelerator program including business center services, management and administrative services, and access to capital via a network of investors; and a virtual set-up to cater for companies that do not need physical space.

FSP 105 provides digital offices (also referred to as virtual offices) for tenants unable to or not ready to lease physical space in property 110. A digital office provides a business address without an actual physical presence.

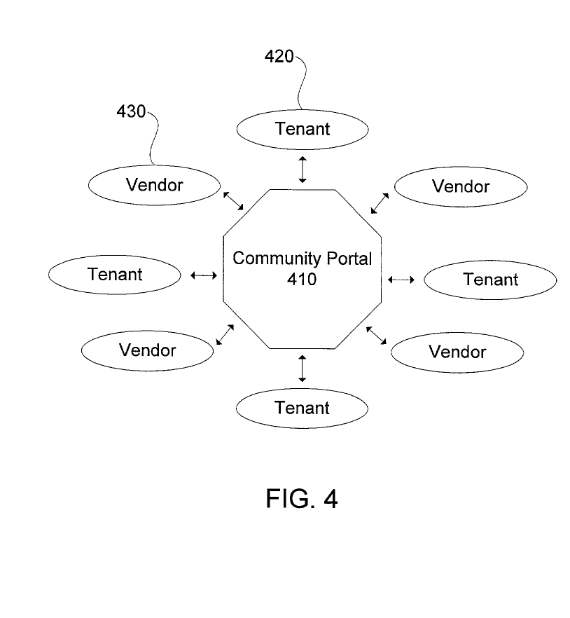

FSP 105 provides a community portal, with intranet capabilities, to enable the members of the network 100 to shop, sell, acquire office needs and services (supplies, logistics, etc.), book restaurant reservations and air tickets online, rent a car, search for the latest traffic conditions within and without of property 110, get information on latest shopping offers, determine foreign currency exchange rates, etc. The community portal will be discussed in further detail in conjunction with FIG. 4.

A common telecommunications connection provided by FSP 105 enables tenants to communicate with each other at no cost, thereby encouraging networking and increasing the value of network 100. The telecommunications connection can also be linked with nearby hotels and other service providers to enable visitors to easily arrange for hotel accommodations.

An Internet call center enables tenants to provide online customer support for their websites to build relationships with their customer and boost online sales.

The InfoCam system includes large screens or monitors and cameras at strategic locations within property 110 to provide useful information, such as live traffic and stock information, to tenants and visitors.

FSP 105 provides a club house within property 110 to provide an exercise environment for networking among tenants. The club house includes a gymnasium, swimming pool, spa, sauna, tennis courts, and golf driving ranges, etc. FSP 105 also arranges networking meetings on a regular basis so as to encourage networking among tenants.

FSP 105 provides a car park in property 110 for parking of tenants' and visitors' vehicles. FSP 105 also provides security to property 110, which includes regularly scheduled patrolling by uniformed security agents and showcasing a security command center by encasing the command center behind a glass wall or other transparent barrier.

Second wave 320 includes information technology initiatives, a combination physical and virtual mall (also referred to as a “click & brick mall”), video conferencing facilities that enable the tenants to communicate with one another as well as their counterparts overseas, a B2B (e-procurement) portal that enables tenants to make purchases online, and a plug & play environment of property 110 tenants. A plug & play environment in property 110 includes leasing of computer hardware; application service provider (ASP) services; E-Administration; a total wireless environment; and a fourth generation (4G) wireless network. Leasing of computers to tenants 115, 120-n enables tenants 115, 120-n to save substantial amounts of money off any initial investment in hardware and office equipment as cost of the hardware is spread over months. Further, tenants 115, 120-n will be able to lease the latest equipment without fear of obsolescence.

Due to aggregation of purchasing power from tenants 115, 120-n, FSP 105 can negotiate for reduced costs and higher services rates for ASP services. An E-Administration system with built-in workflow, queue management features, and integrated to an e-billing system enables tenants 115, 120-n and visitors to book and pay for facilities in property 110 such as meeting rooms, exhibition halls, tennis courts, etc.

A total wireless environment enables tenants 115, 120-n and visitors to property 110 to access the Internet at high speed and also make use of advanced IP services and other applications, anywhere within the premises of property 110 without requiring wired connections.

A 4G network will enable tenants 115, 120-n and visitors to access the Internet and other services at higher speeds than conventional wireless networks, thereby enabling a whole new series of wireless applications. In one embodiment of the invention, property 110 has installed a 4G network using orthogonal frequency division multiplexing (OFDM) capable to deliver data at a rate of over 20 Mbps.

A click & brick mall includes a point of sale (POS) system, a customized privilege card program, and an e-tailing portal. A web-based POS enables merchant tenants to track online and offline sales, manage their inventory level, reduce unnecessary procedures and make changes at their own rate.

A loyalty card program will use a web-enabled card-based customer relations management (CRM) program enabling merchant tenants to reward genuine customers. Based on data collected from customers using loyalty cards, merchant tenants will be able to gain valuable knowledge about customers' purchasing habits and will further be able to tailor inventories and promotions based on these customer habits.

A virtual mall enables merchant tenants to sell their products and/or services to a mass market with only minimal incremental cost. Shoppers will be able to virtually shop in property 110 and enjoy rewards a from the loyalty card program. An interactive virtual assistant will assist visitors in navigation of the virtual mall. The virtual assistant uses artificial intelligence to remember visitors' identities and react to them accordingly. Second wave 320 also includes M-commerce enabling customers to wirelessly navigate the virtual mall and make purchases.

Third wave 330 enables FSP 105 to increase the value of network 100 by communicatively coupling the network 100 to an international community by using new technology as it becomes available.

FIG. 4 is a block diagram illustrating a community portal 410. Community portal 410 also includes ASP services available through the portal. Through the portal 410, tenants, such as tenant 420, will be able to communicate with vendors, such as vendor 430. Tenants can arrange for and purchase services and products from the vendors, which may also be tenants. The vendors communicatively coupled to the portal are also pre-approved (meet quality, price, and/or other standards) by FSP 105 so that tenants know that they are dealing with acceptable vendors.

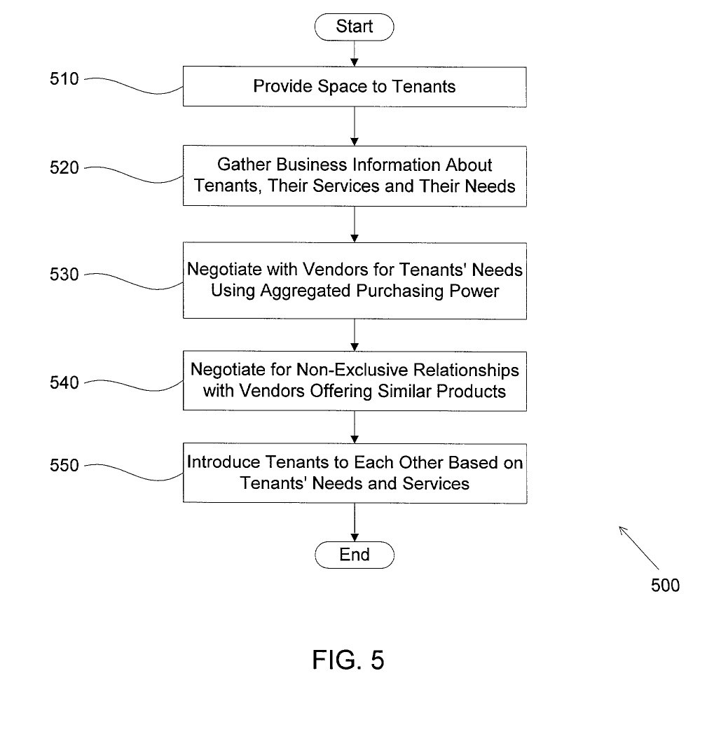

FIG. 5 is a flowchart illustrating a method 500 for increasing perceived value of a property. In an embodiment of the invention FSP 105 implements method 500. First, an FSP, such as FSP 105, provides (510) space, such as physical portions of property 110 or virtual offices, to tenants in exchange for money. In an alternative embodiment, FSP 105 accepts equity (stock, convertible bonds, etc.) in tenants in lieu of or in addition to money.

Next, an FSP, such as FSP 105, gathers (520) business information about tenants residing in the property, such as property 110. FSP 105 gathers (520) business information via questionnaires, online forms, surveys, in-person meetings, etc. The gathered information can then be stored in computers or paper files. Business information may include the services and/or product offerings of tenants (such as tenants 115, 120-n) and their needs, such as computer hardware and software, consulting, office products, etc.

Based on gathered information, the FSP, such as FSP 105, then negotiates (530) for tenants' needs with third party vendors using aggregated purchasing power from a plurality of tenants having similar needs, thereby reducing the costs for tenants to purchase services and/or products to satisfy their requirements. In an alternative embodiment of the invention, the third party vendors are tenants in the property 110.

Further, the FSP, such as FSP 105 can also negotiate (540) for non-exclusive relationships with third party vendors that offer similar or identical products and/or services, thereby pre-qualifying the vendors and forcing the vendors to compete with each other for tenants' business based on price and access to services. For example, FSP 105 may negotiate with several broadband providers to supply broadband connections to tenants. Accordingly, the broadband providers would then have to compete against each other based on cost and other factors to supply broadband to each individual tenant.

To further increase perceived value of a property, the FSP, such as FSP 105, introduces (550) tenants to each other based on their needs and product and/or service offerings. For example, FSP 105 may introduce a tenant needing computer hardware to a tenant selling computer hardware. Introductions can be done via any of the services mention in first wave 310, second wave 320, third wave 330, or other techniques. Accordingly, FSP 105 enables easier access to potential customers for tenants providing products and services and enable easier acquisition of products and/or services for tenants looking for the same.

The foregoing description of the illustrated embodiments of the present invention is by way of example only, and other variations and modifications of the above-described embodiments and methods are possible in light of the foregoing teaching. For example, FSP 105 may accept products or services in lieu of rent or equity for providing space in property 110 to tenants. The present invention is limited only by the following claims.

What is claimed is:

1. A method, comprising:
providing space in a property to tenants;
gathering business information about tenants in the property; and
introducing tenants to each other based on the gathered business information so that tenants may consummate business relationships.

2. The method of claim 1, further comprising negotiating for non-exclusive business relationships with vendors to supply tenants with similar services.

3. The method of claim 1, further comprising negotiating for non-exclusive business relationships with vendors to supply tenants with similar products.

4. The method of claim 1, further comprising receiving services from at least one tenant as at least a portion of consideration for providing space to the at least one tenant.

5. The method of claim 1, further comprising receiving equity from at least one tenant as at least a portion of consideration for providing space to the at least one tenant.

6. The method of claim 1, wherein the business information includes tenants' needs, product offerings, and service offerings.

7. The method of claim 1, further comprising providing an intranet portal accessible to tenants for tenants to communicate with each other.

8. The method of claim 1, further comprising providing a virtual/physical mall for tenants to sell products and services both online and in person.

9. The method of claim 8, further comprising providing a loyalty card program so that merchant tenants can track customer purchases and reward customers based on amount of purchases.

10. The method of claim 1, further comprising providing a start up incubator to tenants.

11. The method of claim 1, further comprising providing at least one virtual office to at least one tenant.

12. The method of claim 1, wherein the space includes at least one virtual office.

13. The method of claim 1, wherein the space includes a physical portion of the property.

14. A system, comprising:
means for providing space in a property to tenants;
means for gathering business information about tenants in the property;
means for introducing tenants to each other based on the gathered business information so that tenants may consummate business relationships.

15. The system of claim 14, further comprising means for negotiating for non-exclusive business relationships with vendors to supply tenants with similar services.

16. The system of claim 14, further comprising means for negotiating for non-exclusive business relationships with vendors to supply tenants with similar products.

17. The system of claim 14, further comprising means for receiving services from at least one tenant as at least a portion of consideration for providing space to the at least one tenant.

18. The system of claim 14, further comprising means for receiving equity from at least one tenant as at least a portion of consideration for providing space to the at least one tenant.

19. The system of claim 14, wherein the business information includes tenants' needs, product offerings, and service offerings.

20. The system of claim 14, further comprising means for providing an intranet portal accessible to tenants for tenants to communicate with each other.

21. The system of claim 14, further comprising means for providing a virtual/physical mall for tenants to sell products and services both online and in person.

22. The system of claim 21, further comprising means for providing a loyalty card program so that merchant tenants can track customer purchases and reward customers based on amount of purchases.

23. The system of claim 14, further comprising means for providing a start up incubator to tenants.

24. The system of claim 14, further comprising means for providing at least one virtual office to at least one tenant.

25. A method, comprising:
providing space in a property to tenants;
gathering business information about tenants in the property; and
negotiating with vendors for tenants' needs using tenants' aggregated purchasing power.

26. A system, comprising:
means for providing space in a property to tenants;
means for gathering business information about tenants in the property; and
means for negotiating with vendors for tenants' needs using tenants' aggregated purchasing power.
